(19) United States
(12) Patent Application Publication
(10) Pub. No.: US 2025/0338245 A1
(43) Pub. Date: Oct. 30, 2025

(54) DEVICES, METHODS, APPARATUSES AND COMPUTER READABLE MEDIUM FOR COMMUNICATIONS

(71) Applicant: Nokia Technologies Oy, Espoo (FI)

(72) Inventors: Ryan KEATING, Naperville, NJ (US); Hyun-Su CHA, Naperville, IL (US); Yong LIU, Shanghai (CN)

(21) Appl. No.: 18/998,372

(22) PCT Filed: Sep. 30, 2022
(86) PCT No.: PCT/CN2022/123156

§ 371 Date: Jan. 24, 2025

(51) Int. Cl. H04W 64/00; H04J 13/00; H04L 5/00; H04W 72/02; H04W 72/25; H04W 92/18

(52) U.S. Cl. CPC H04W 64/00; H04J 13/004; H04L 5/0051; H04W 72/02; H04W 72/25; H04W 92/18

(57) ABSTRACT

Embodiments of the present disclosure disclose devices, methods and apparatuses for a beam reporting. A first terminal device receives a plurality of sidelink (SL) positioning reference signal (PRS) configurations from a plurality of terminal devices. The first terminal device determines, based on the plurality of SL PRS configurations, whether the plurality of terminal devices select overlapping resources for a plurality of SL PRS transmissions. Based on determining that the plurality of terminal devices select overlapping resources for the plurality of SL PRS transmissions, the first terminal device transmits, to a second terminal device among the plurality of terminal devices, a request to update an SL PRS transmission by the second terminal device.

### FIELD

Embodiments of the present disclosure generally relate to the field of communication, and in particular, to devices, methods, apparatuses and computer readable storage medium for communications.

### BACKGROUND

With the development of communication technology, positioning technology was introduced so that a device in a communication system can be positioned. The positioning technology includes angle of arrival (AOA) positioning technology, time difference of arrival (TDOA) positioning technology, round trip time (RTT) positioning technology and so on. In general, a device to be positioned receives reference signals (for example, positioning reference signal, PRS) from one or more assistance devices, or the device transmits reference signals to the one or more assistance devices. Then, the position of this device may be estimated or calculated by measuring the reference signals.

In the situation where the terminal devices communicate with each other via a sidelink (SL), the terminal device may be positioned by measuring the reference signals transmitted from the other terminal devices which are able to communicate with the terminal device. In this case, the coordination between SL PRSs transmitted by different terminal devices is also a key aspect.

### SUMMARY

In general, example embodiments of the present disclosure provide devices, methods, apparatuses and computer readable storage medium for beam reporting.

In a first aspect, there is provided a first terminal device. The first terminal device may comprise at least one processor; and at least one memory storing instructions that, when executed by the at least one processor, cause the first terminal device to: receive a plurality of sidelink (SL) positioning reference signal (PRS) configurations from a plurality of terminal devices; determine, based on the plurality of SL PRS configurations, whether the plurality of terminal devices select overlapping resources for a plurality of SL PRS transmissions; and based on determining that the plurality of terminal devices select overlapping resources for the plurality of SL PRS transmissions, transmit, to a second terminal device among the plurality of terminal devices, a request to update an SL PRS transmission by the second terminal device.

In a second aspect, there is provided a second terminal device. The second terminal device may comprise at least one processor; and at least one memory storing instructions that, when executed by the at least one processor, cause the second terminal device to: transmit a sidelink (SL) positioning reference signal (PRS) configuration to a first terminal device; receive a request to update an SL PRS transmission; and update, in accordance with a determination that the SL PRS is to be update, the SL PRS transmission based on the request.

In a third aspect, there is provided a network device. The network device may comprise at least one processor; and at least one memory storing instructions that, when executed by the at least one processor, cause the network device to: transmit a muting criterion for determining sidelink (SL) positioning reference signal (PRS) to be muted to a first terminal device; and transmit an indication of a muting pattern to a second terminal device.

In a fourth aspect, there is provided a method implemented at a first terminal device. The method comprises: receiving a plurality of sidelink (SL) positioning reference signal (PRS) configurations from a plurality of terminal devices; determining, based on the plurality of SL PRS configurations, whether the plurality of terminal devices select overlapping resources for a plurality of SL PRS transmissions; and based on determining that the plurality of terminal devices select overlapping resources for the plurality of SL PRS transmissions, transmitting, to a second terminal device among the plurality of terminal devices, a request to update an SL PRS transmission by the second terminal device.

In a fifth aspect, there is provided a method implemented at a second terminal device. The method comprises: transmitting a sidelink (SL) positioning reference signal (PRS) configuration to a first terminal device; receiving a request to update an SL PRS transmission; and updating, in accordance with a determination that the SL PRS is to be updated, the SL PRS transmission based on the request.

In a sixth aspect, there is provided a method implemented at a network terminal device. The method comprises: transmitting, at a network device, a muting criteria for determining sidelink (SL) positioning reference signal (PRS) to be muted to a first terminal device; and transmitting an indication of muting pattern to a second terminal device.

In a seventh aspect, there is provided an apparatus of a first terminal device. The apparatus comprises: means for receiving a plurality of sidelink (SL) positioning reference signal (PRS) configurations from a plurality of terminal devices; means for determining, based on the plurality of SL PRS configurations, whether a plurality of terminal devices select overlapping resources for a plurality of sidelink (SL) positioning reference signal (PRS) transmissions; and means for based on determining that the plurality of terminal devices select overlapping resources for the plurality of SL PRS transmissions, transmit, to a second terminal device among the plurality of terminal devices, a request to update an SL PRS transmission by the second terminal device.

In an eighth aspect, there is provided an apparatus of a second terminal device. The apparatus comprises: means for transmitting a sidelink (SL) positioning reference signal (PRS) configuration to a first terminal device; means for receiving a request to update an SL PRS transmission; and means for updating, in accordance with a determination that the SL PRS is to be updated, the SL PRS transmission based on the request.

In a ninth aspect, there is provided an apparatus of a network device. The apparatus comprises: means for transmitting, at a network device, a muting criterion for determining sidelink (SL) positioning reference signal (PRS) to be muted to a first terminal device; and means for transmitting an indication of muting pattern to a second terminal device.

In an tenth aspect, there is provided a non-transitory computer readable medium comprising program instructions for causing an apparatus to perform at least the method according to any of fourth to sixth aspects.

In an eleventh aspect, there is provided a computer program comprising instructions, which, when executed by an apparatus, cause the apparatus at least to: receive a plurality of sidelink (SL) positioning reference signal (PRS) configurations from a plurality of terminal devices; determine, based on the plurality of SL PRS configurations, whether the plurality of terminal devices select overlapping resources for a plurality of SL PRS transmissions; and based on determining that the plurality of terminal devices select overlapping resources for the plurality of SL PRS transmissions, transmit, to a second terminal device among the plurality of terminal devices, a request to update an SL PRS transmission by the second terminal device.

In an twelfth aspect, there is provided a computer program comprising instructions, which, when executed by an apparatus, cause the apparatus at least to: transmit a sidelink (SL) positioning reference signal (PRS) configuration to a first terminal device; receive a request to update an SL PRS transmission; and update, in accordance with a determination that the SL PRS is to be update, the SL PRS transmission based on the request.

In an thirteenth aspect, there is provided a computer program comprising instructions, which, when executed by an apparatus, cause the apparatus at least to: transmit a muting criterion for determining sidelink (SL) positioning reference signal (PRS) to be muted to a first terminal device; and transmit an indication of a muting pattern to a second terminal device.

In a fourteenth aspect, there is provided a first terminal device. The first terminal device comprises receiving circuitry configured to: receive a plurality of sidelink (SL) positioning reference signal (PRS) configurations from a plurality of terminal devices; determining circuitry configured to determine, based on the plurality of SL PRS configurations, whether the plurality of terminal devices select overlapping resources for a plurality of SL PRS transmissions; and transmitting circuitry configured to based on determining that the plurality of terminal devices select overlapping resources for the plurality of SL PRS transmissions, transmit, to a second terminal device among the plurality of terminal devices, a request to update an SL PRS transmission by the second terminal device.

In a fifteenth aspect, there is provided a second terminal device. The second terminal device comprises transmitting circuitry configured to transmit a sidelink (SL) positioning reference signal (PRS) configuration to a first terminal device; receiving circuitry configured to receive a request to update an SL PRS transmission; and updating circuitry configured to update, in accordance with a determination that the SL PRS is to be update, the SL PRS transmission based on the request.

In a sixteenth aspect, there is provided a network device. The network device comprises a first transmitting circuitry configured to transmit a muting criterion for determining sidelink (SL) positioning reference signal (PRS) to be muted to a first terminal device; and a second transmitting circuitry configured to transmit an indication of a muting pattern to a second terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates an example signaling process for SL positioning according to some embodiments of the present disclosure;

FIG. 3 illustrates another example signaling process for SL positioning according to some embodiments of the present disclosure;

FIG. 4 illustrates flowchart of a method implemented at a first terminal device according to example embodiments of the present disclosure;

FIG. 5 illustrates an example flowchart of a method implemented at a second terminal device according to example embodiments of the present disclosure;

FIG. 6 illustrates an example flowchart of a method implemented at a network device according to example embodiments of the present disclosure;

FIG. 7 illustrates an example simplified block diagram of an apparatus that is suitable for implementing embodiments of the present disclosure; and

FIG. 8 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the coordination between SL PRSs transmitted by different terminal devices may be an important aspect for the SL positioning. In the SL positioning, the terminal device to be positioned (which may be also referred to as a target terminal device or “T-UE” in this disclosure) utilizing other terminal devices (which may be also referred to as supporting terminal devices or “S-UEs”) to assist in the positioning session. In some cases, for example under mode 2 for SL positioning, the supporting terminal devices may autonomously select the time frequency resources for transmitting the SL positioning reference signal (PRS). In turn, the supporting terminal devices may select the same time frequency resource to transmit the SL PRS respectively. As such, the measurements on SL PRSs from different supporting terminal devices may interfere with each other. In one solution, the SL PRS configuration for supporting terminal device may be pre-configured, such that the time frequency selected by a supporting terminal device is different from that selected by another supporting terminal device. However, even if the SL PRS configuration is pre-configured, the resource conflict or the measurement interference may still occur.

At least for solving the above issues and improving the performance of a communication system, a scheme for SL positioning is provided. In this scheme, a first terminal device receives a plurality of sidelink (SL) positioning reference signal (PRS) configurations from a plurality of terminal devices. Based on the plurality of SL PRS configurations, the first terminal device determines whether the plurality of terminal devices select overlapping resources (e.g., time-frequency resources that been selected by more than one terminal device) for a plurality of SL PRS transmissions. If the plurality of terminal devices selects overlapping resources for the plurality of SL PRS transmissions, the first terminal device transmits, to a second terminal device among the plurality of terminal devices, a request to update or adjust an SL PRS transmission or a parameter or a characteristic thereof by the second terminal device. It is to be understood that although the embodiments are mostly discussed with reference to the SL PRS, the SL PRS is only an example of the reference signals that are used for SL positioning. Furthermore, any other signals that can be used or reused for SL positioning the device is also covered in this disclosure.

In this way, even if the supporting terminal devices have actually selected overlapping resources, the target terminal device may also coordinate the resource conflict or measurement interference in a dynamic manner without completely re-configuring the SL PRS configuration.

In this disclosure, the overlapping resources refer to the same communication resources that are selected by more than one supporting terminal device for transmitting the SL PRSs. Without any limitation, in some cases, the same communication resources may be a time-frequency resource. Without any limitation, in some cases, the same communication resources may be the same resource elements or resource blocks. Alternatively, the same communication resources may be any other communication resources, for example, polarization resource, spatial orientation resource, and so on.

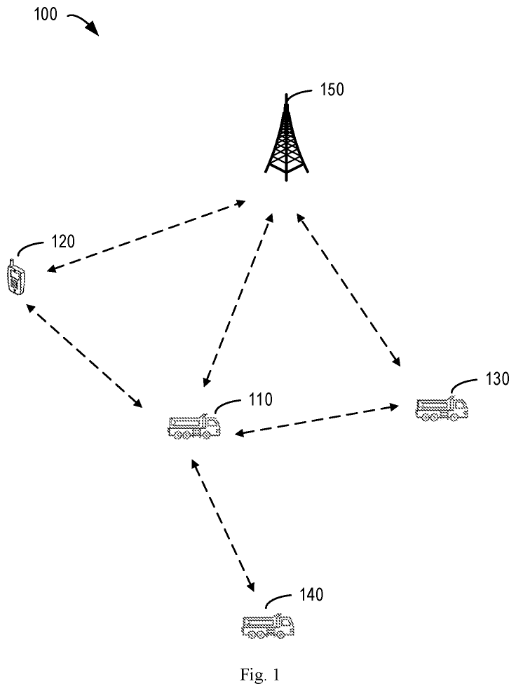

Principle and embodiments of the present disclosure will be described in detail below with reference to the accompanying drawings. FIG. 1 illustrates an example network environment 100 in which example embodiments of the present disclosure may be implemented. The environment 100, which may be a part of a communication network, includes terminal devices and network devices.

As illustrated in FIG. 1, the network environment 100 may include terminal devices, 110, 120, 130 and 140. Just for sake of discussion and without any limitation, the terminal device 110 is the terminal device to be positioned via sidelink communication, and this terminal device 110 may be also referred to as the first terminal device 110 in this disclosure. In addition, the terminal devices 120, 130 and 140 are the supporting terminal devices that assist to position the first terminal device 110. Without any limitation, the terminal device 120 may be also referred to as the second terminal device 120, the terminal device 130 may be also referred to as the third terminal device 130, and the terminal device 140 may be also referred to as the fourth terminal device 140. The network environment 100 further includes a network device 150 that may serve the terminal devices as mentioned above.

It is to be understood that the number of network devices and terminal devices is given only for the purpose of illustration without suggesting any limitations. The system 100 may include any suitable number of network devices and/or terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G), the fifth generation (5G) or beyond, wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connection (DC), and new radio unlicensed (NR-U) technologies.

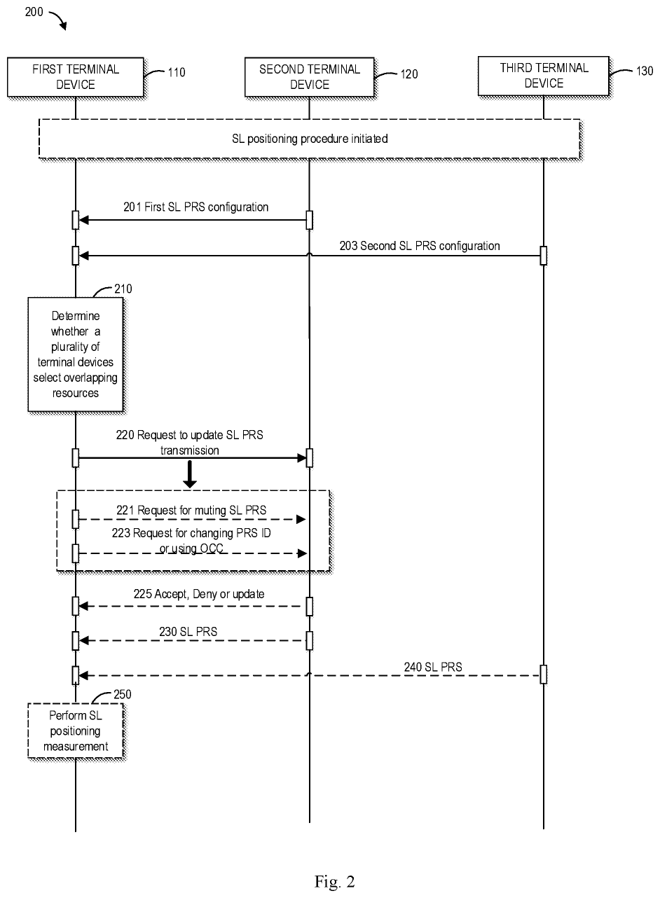

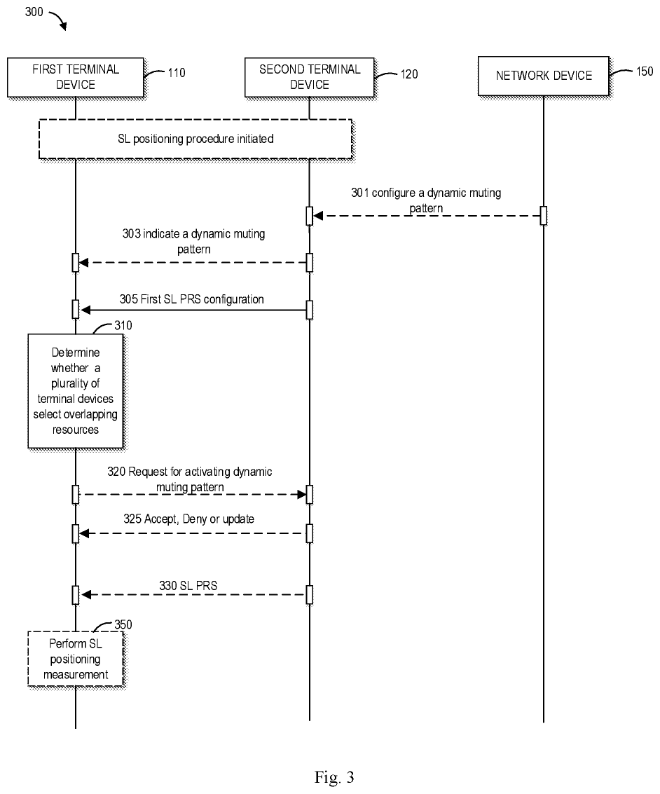

In this disclosure, an SL positioning procedure is proposed, and the embodiments are further discussed with reference to FIGS. 2 and 3.

FIG. 2 illustrates an example signaling process 200 for SL positioning according to some embodiments of the present disclosure. For the purpose of discussion, the process 200 will be described with reference to FIG. 1. It would be appreciated that although the process 200 has been described in the communication environment 100 of FIG. 1, this process 200 may be likewise applied to other communication scenarios. For illustrative purposes, the following embodiments are discussed with reference to the first terminal device 110, the second terminal device 120, the third terminal device 130, and the network device 150 without any limitation.

In the signaling 200, after the SL positioning procedure is initiated, the first terminal device 110 receives (201, 203) a plurality of SL PRS configurations from a plurality of terminal devices. Without any limitation, the plurality of terminal devices may comprise the second terminal device 120, third terminal device 130, and the fourth terminal device 140. As shown in FIG. 2, the first terminal device 110 receives (201) a first SL PRS configuration from the second terminal device 120 and receives (203) a second SL PRS configuration from the third terminal device 130. In other embodiments, the first terminal device 110 may also receive a third SL PRS configuration from the fourth terminal device 140. The SL PRS configuration (for example, the first SL PRS configuration) may indicate the resources (for example, time-frequency resources) that are selected by a respective supporting terminal device (for example, the second terminal device 120) for transmitting the SL PRS. Alternatively, the supporting terminal device (for example, the second terminal device 120) may also relay a SL PRS configuration (for example, the second SL PRS configuration) from another supporting terminal device (for example, the third terminal device 130) to the first terminal device 110. The protection scope regarding this respect is not limited.

Based on the plurality of SL PRS configuration, the first terminal device 110 determines (210) whether the plurality of terminal devices select overlapping resources (e.g., the same time-frequency resources) for a plurality of SL PRS transmissions. In some embodiments, if the resources indicated by a SL PRS configuration (for example, the first SL PRS configuration) at least partially overlaps with the resources indicated by another SL PRS configuration (for example, the second SL PRS configuration), then the first terminal device 110 may determine that the plurality of terminal devices comprising the second terminal device 120 and the third terminal device 130 selects overlapping resources. Alternatively, if the second terminal device 120 and the third terminal device 130 at least partially select the same resources, the first terminal device 110 may determine that the plurality of terminal devices comprising the second terminal device 120 and the third terminal device 130 selects overlapping resources.

Upon determining that the plurality of terminal devices select overlapping resources for the plurality of SL PRS transmissions, the first terminal device 110 transmits (220) a request to update an SL PRS transmission to the second terminal device 120. In some embodiments, “updating an SL PRS transmission” means adjusting a multiplexing method to transmit a SL PRS, and the multiplexing scheme is one of muting (zero-power transmission) the SL PRS or utilizing Code Division Multiplexing (CDM). CDM means using different sequence by using the different sequence initialization value or using the orthogonal cover code (OCC) in the time-domain and/or the frequency-domain. In addition, the “update an SL PRS transmission” may be also referred to as “update a SL PRS configuration”.

In some embodiments, the request may include (221) a request for muting a SL PRS. For example, the first terminal device 110 may transmit the request for muting the SL PRS that is transmitted on the overlapping resources to the second terminal device 120. If the second terminal device 120 determines that the SL PRS can be updated or muted, then the second terminal device 120 may mute the corresponding SL PRS based on the request. In addition, the second terminal device 120 may feedback (225) to the first terminal device 110 with an accept message indicating that the muting request is accepted or otherwise complied with. Furthermore, the second terminal device 120 may also transmit (225) to other target terminal devices and/or the first terminal device 110 an update message indicating that the SL PRS is muted.

Otherwise, if the second terminal device 120 determines that the SL PRS cannot be muted for other reasons, the second terminal device 120 may feedback (225) to the first terminal device with a deny message indicating that the muting request cannot be accepted or complied with and that the SL PRS is not muted. Based on the deny message, the first terminal device 110 may transmit the request for muting the SL PRS to another terminal device (for example, the third terminal device 130) among the plurality of terminal devices. Alternatively, the first terminal device 110 may perform other corresponding actions to eliminate the interference.

In some embodiments, the request for muting the SL PRS may further indicate that the SL PRS is to be muted in certain slots. As such, the second terminal device 120 may only mute the SL PRS in the certain slots (which may be also referred to as a first slot) and still transmit the SL PRS in other allocated resources. In this case, one or more occasions of the SL PRS may be muted. In addition, the terminal device 110 may also transmit a request for muting the SL PRS in other specific slots (which may be also referred to as a second slot) to the third terminal device 130. In some embodiments, the first slot and the second slot are staggered (e.g., using different slots so as to not overlap) in the time domain. For example, the first slot and the second slot are in different slots, or the first slot and the second slot are respectively positioned at different locations of a periodic time slot. Specifically, the first terminal device 110 may request the second terminal device 120 to mute SL PRS during slot x, while the first terminal device 110 asks the third terminal device 130 to mute SL PRS during slot x+n (where n is the periodicity of the SL PRS).

In addition or alternatively, the first terminal device 110 may transmit the request to mute the strongest received SL PRS signal. In some embodiments, the first terminal device 110 may receive a first SL PRS from the second terminal device 120 and a second SL PRS from a third terminal device 130 on the overlapping resources. If the first terminal device 110 determines that a first received power (for example, reference signal received power, RSRP) of the first SL PRS is greater than a second received power of the second SL PRS by a power threshold. Then, the first terminal device may transmit the request for muting the first SL PRS to the second terminal device 120. Alternatively, if the difference between RSRPs of SL PRSs from different terminal devices is great enough, the first terminal device 110 may request for muting the SL PRS having the greater RSRP to a respective terminal device. In this way, the first terminal device 110 may measure the SL PRS having the smaller received power during the slots when the strongest SL PRS is muted. Further, during the slots in which the strongest the SL PRS is still transmitted (for example, the strongest SL PRS is muted only in certain slots), the first terminal device 110 may measure the strongest SL PRS relying on the Code Division Multiplexing (CDM), while knowing there will be some interference impact.

In addition or alternatively, the first terminal device 110 may also determine the SL PRS to be muted based on a predefined criterion. In some embodiments, the first terminal device 110 may receive the muting criterion for determining the SL PRS to be muted from the network device 150. In some embodiments, the muting criterion may indicate that only the SL PRS with certain characteristics can be requested to be muted. In an example, the SL PRS with certain characteristics may comprise the SL PRSs having received power higher than a second power threshold. In turn, the first terminal device 110 may request to mute these SL PRSs. In this case, the network device 150 may configure the second power threshold as X. Then, if a SL PRS RSRP>X, the terminal device 110 may request to mute this SL PRS.

Regarding the transmission of the request for muting the SL PRS or the request to update the SL PRS transmission, the first terminal device 110 may transmit the request to the second terminal device 120 via sidelink control information (SCI) signaling. In addition or alternatively, the first terminal device 110 may also transmit the request to the second terminal device 120 via a sidelink LTE positioning protocol (SLPP) message. In addition or alternatively, the first terminal device 110 may also transmit the request via a group cast signaling to mute the SL PRS transmitted from a group of terminal devices among the plurality of terminal devices. In addition, the first terminal device 110 may also request for muting other resources associated with the SL PRS. For example, if the second terminal device 120 supports beamforming or spatial filtering, the first terminal device 110 may transmit a request for muting a beam associated with the SL PRS transmission.

In addition to the request for muting the SL PRS or alternatively, the request to update the SL PRS transmission may comprise at least one of a request for changing an SL PRS Identification (ID) or a request for using an orthogonal cover code (OCC). In some embodiments, the SL PRS ID may be used to generate the SL PRS sequence. Alternatively, in some other embodiments, t the SL PRS ID may be the seed for a sequence initialization. In some embodiments, the SL PRS ID is associated with a sequence (for example, a pseudorandom code sequence) that is used for performing the CDM communication. As such, the second terminal device 120 may change the code sequence for the SL PRS transmission to the first terminal device 110 based on the request. Alternatively, the second terminal device 120 may use the OCC for the SL PRS transmission to the first terminal device based on the request for using the OCC. In this way, the different SL PRSs transmitting on the overlapping resources can be distinguished utilizing the code sequence, such that the interference of measurement can be eliminated.

In some embodiments, the request may further indicate at least one of an SL PRS ID or an SL PRS sequence initialization. In an example, the indicated SL PRS ID may be the preferred SL PRS ID selected by the first terminal device 110. The second terminal device 120 may change to use the code sequence corresponding to the indicated SL PRS ID. In some embodiments, the first terminal device 110 may transmit the request to change SL PRS ID or using an orthogonal cover code (OCC) based on pre-conditions being satisfied. In some cases, the pre-condition may be that the distance from the supporting terminal devices and the first terminal device 110 are approximately the same. In an example, the first terminal device 110 may determine a first distance between the first terminal device 110 and the second terminal device 120 and determine a second distance between the first terminal device 110 and the third terminal device 130 of the plurality of terminal devices. If the distance difference between the first distance and the second distance satisfies a distance threshold, the first terminal device 110 may transmit the request for changing the SL PRS ID or the request for using the OCC to the second terminal device 120. In this way, it can enable Code Division Multiplexing (CDM) at the T-UE, rather than full muting the S-UEs. Otherwise, if the first terminal device 110 estimates the difference between distances from terminal devices 120 and 130 is larger than a threshold the first terminal device 110 falls back to muting request rather than request to change SL PRS. In addition, the second terminal device 120 may also feedback (225) to the first terminal device 110 with an accept message, deny message, or update message in the same way as mentioned above. In turn, the first terminal device 110 may perform corresponding actions as mentioned above. Furthermore, if the second terminal device 120 changed the SL PRS ID, the second terminal device 120 may also inform the other target terminal devices with the updated SL PRS ID.

As mentioned above, the resource conflict or measurement interference can be eliminated by dynamically informing the S-UEs to update the SL PRS transmission. As such, the S-UE can update the SL PRS transmissions without completely reconfiguring the SL PRS configuration. Thereby, it minimizes the latency impact. There may also be other T-UEs which are listing to the S-UE SL PRS transmission so muting of a small number of occasions brings the least disruptive solution.

Still referring to FIG. 2, the first terminal device 110 receives (230, 240) SL PRSs from the second terminal device 120 and the third terminal device 130 and then performs (250) SL positioning measurement.

In addition or alternatively, the supporting terminal devices may be configured with a dynamic muting pattern. Moreover, the muting pattern can be activated when detecting measurement interference. For sake of discussion, the dynamic muting pattern is further discussed with reference to FIG. 3.

FIG. 3 illustrates another example signaling process 300 for SL positioning according to some embodiments of the present disclosure. For the purpose of discussion, the process 200 will be described with reference to FIG. 1. It would be appreciated that although the process 200 has been described in the communication environment 100 of FIG. 1, this process 200 may be likewise applied to other communication scenarios. For illustrative purposes, the following embodiments are discussed with reference to the first terminal device 110, the second terminal device 120, the third terminal device 130, and the network device 150 without any limitation.

Without any limitation, the step 305 may be performed in the same way as the steps 201 or 203 in FIG. 2. The steps 310 and 325 may be performed in the same way as the steps 210 and 225, respectively, in FIG. 2. The steps 330 and 350 may be performed in the same way as the steps 230 and 250, respectively, in FIG. 2.

As shown in signaling process 300, after the SL positioning procedure is initiated, the network device 150 may configure the second terminal device 120 with a dynamic muting pattern. In some embodiments, the network device 150 may transmit an indication of a muting pattern to the second terminal device 120. The second terminal device 120 may transmit the indication to the first terminal device 110 so that the first terminal device 110 is aware that the second terminal device 120 has a muting pattern. Then, the first terminal device 110 may determine that the plurality of terminal devices comprising the second terminal device 120 selects overlapping resources (e.g., selecting the same time-frequency resources). The first terminal device 110 may transmit the request for activating the dynamic muting pattern to the second terminal device 120 via SCI. For example, the request may comprise an activation message for activating the muting pattern. Correspondingly, the second terminal device 120 may activate the muting pattern based on receiving the activation message. For example, the second terminal device 120 having a muting pattern configured by gNB/transmission and reception point (TRP)/LMF only activates this muting pattern upon request by the first terminal device 110, such that it is an optional muting pattern. If the location management function (LMF) is configuring the muting pattern it may use LPP to perform it. In addition, a SL PRS configuration of a given S-UE may be used by multiple T-UEs. In order to minimize the disruption, the S-UE may just mute for a short period (e.g., a duration sufficient to avoid interference). Otherwise, full re-configuration of SL PRS may be needed which is time consuming and challenging (as no single entity has all the information).

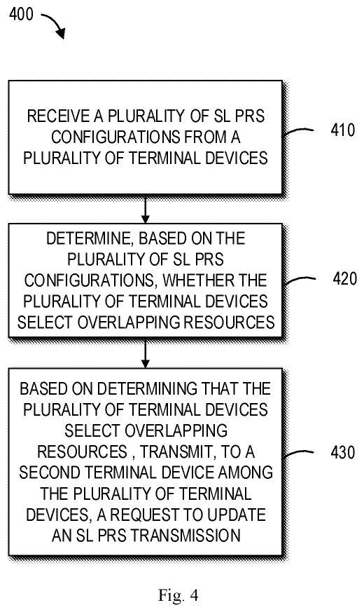

FIG. 4 shows a flowchart of an example method 400 implemented at a terminal device (for example, the first terminal device 110) in accordance with some embodiments of the present disclosure. For the purpose of discussion, the method 400 will be described from the perspective of the terminal device 110 with reference to FIG. 1.

At 410, the first terminal device 110 receives a plurality of sidelink (SL) positioning reference signal (PRS) configurations from a plurality of terminal devices. At 420, the first terminal device 110 determines, based on the plurality of SL PRS configurations, whether the plurality of terminal devices select overlapping resources for a plurality of SL PRS transmissions. At 430, based on determining that the plurality of terminal devices select overlapping resources for the plurality of SL PRS transmissions, the first terminal device 110 transmits, to a second terminal device among the plurality of terminal devices, a request to update an SL PRS transmission by the second terminal device.

In some embodiments, the request comprises a request for muting a SL PRS. In some embodiments, the request further indicates that the SL PRS is muted in a first slot. In some embodiments, the method 400 further comprises transmitting, to a third terminal device of the plurality of terminal devices, the request for muting the SL PRS in a second slot, and the second slot and the first slot being staggered in the time domain. In some embodiments, transmitting the request for muting the SL PRS comprises: receiving a first SL PRS from the second terminal device and a second SL PRS from a third terminal device among the plurality of terminal devices on the overlapping resources; determining that a first received power of the first SL PRS is greater than a second received power of the second SL PRS by a power threshold; and transmitting the request for muting the first SL PRS to the second terminal device.

In some embodiments, the method 400 further comprises transmitting the request for muting the SL PRS by: receiving, from a network device, a muting criterion for determining the SL PRS to be muted; and transmitting, based on the muting criterion, the request to the second terminal device. In some embodiments, the request comprises: a request for muting a beam associated with the SL PRS transmission. In some embodiments, transmitting the request for muting the SL PRS by at least one of: transmitting the request via a sidelink control information (SCI) signaling; transmitting the request via a sidelink LTE positioning protocol (SLPP) message; or transmitting the request via a group cast signaling to mute the SL PRS transmitted from a group of terminal devices among the plurality of terminal devices.

In some embodiments, the method 400 further comprises receiving, from the second terminal device, an indication that the SL PRS is not to be muted; and transmitting the request to a third terminal device other than the second terminal device among the plurality of terminal devices. In some embodiments, the request comprises at least one of: a request for changing an SL PRS identification (ID); or a request for using an orthogonal cover code (OCC). In some embodiments, the request further indicates at least one of: an SL PRS ID, or an SL PRS sequence initialization.

In some embodiments, transmitting the request for changing the SL PRS ID comprises determining a first distance between the terminal device and the second terminal device; determining a second distance between the terminal device and a third terminal device of the plurality of terminal devices; and transmitting, based on a distance difference between the first distance and the second distance satisfying a distance threshold, the request for changing the SL PRS ID or the request for using the OCC to the second terminal device.

In some embodiments, the method 400 further comprises receiving, from the second terminal device, an indication of a muting pattern. In some embodiments, transmitting the request comprises: transmitting, to the second terminal device, an activation message for activating the muting pattern.

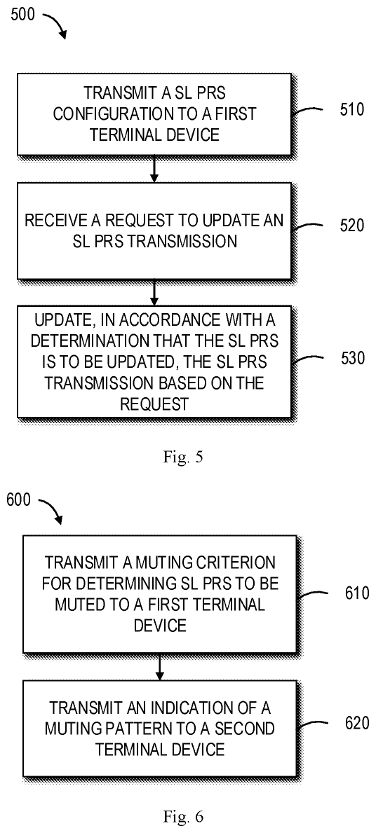

FIG. 5 shows a flowchart of an example method 500 implemented at a terminal device (for example, the second terminal device 120) in accordance with some embodiments of the present disclosure. For the purpose of discussion, the method 500 will be described from the perspective of the second terminal device 120 with reference to FIG. 1.

At 510, the second terminal device 120 transmits a sidelink (SL) positioning reference signal (PRS) configuration to a first terminal device. At 520, the second terminal device 120 receives a request to update an SL PRS transmission. At 530, the second terminal device 120 updates, in accordance with a determination that the SL PRS is to be update, the SL PRS transmission based on the request.

In some embodiments, the request comprises a request for muting a SL PRS. In some embodiments, the request comprises: a request for muting a beam associated with the SL PRS.

In some embodiments, updating the SL PRS transmission may be performed by at least one of: muting transmitting the SL PRS based on the request; or disabling the beam associated with the SL PRS.

In some embodiments, the second terminal device 120 avoids transmitting the SL PRS, and the second terminal device 120 is further caused to: transmit, to another terminal device to be positioned, an indication that the SL PRS is muted.

In some embodiments, the method 500 further comprises transmitting, in accordance with a determination that the SL PRS is not to be updated, an indication that the SL PRS is not to be muted.

In some embodiments, the request comprises at least one of: a request for changing a SL PRS Identification (ID); or a request for using an orthogonal cover code (OCC).

In some embodiments, the request further indicates at least one of: n SL PRS ID, or an SL PRS sequence initialization.

In some embodiments, the method 500 further comprises at least one of: changing, based on the request for changing a SL PRS ID, the code sequence for the SL PRS transmission to the first terminal device; and using, based on the request for using the OCC, the OCC for the SL PRS transmission to the first terminal device 110.

In some embodiments, the method 500 further comprises receiving, from a network device 150, an indication of muting pattern; and transmitting, to the first terminal device 110, the indication of the muting pattern.

In some embodiments, the method 500 further comprises receiving, from the first terminal device 110, an activation message for activating the muting pattern; and activating the muting pattern.

FIG. 6 shows a flowchart of an example method 600 implemented at a network device (for example, the network device 150) in accordance with some embodiments of the present disclosure. For the purpose of discussion, the method 600 will be described from the perspective of the network device 150 with reference to FIG. 1.

At 610, the network device 150 transmits a muting criterion for determining sidelink (SL) positioning reference signal (PRS) to be muted to a first terminal device 110. At 620, the network device 150 transmits an indication of a muting pattern to a second terminal device 120.

In some embodiments, an apparatus capable of performing any of operations of the method 400 (for example, the first terminal device 110) may include means for receiving a plurality of sidelink (SL) positioning reference signal (PRS) configurations from a plurality of terminal devices; means for determining, based on the plurality of SL PRS configurations, whether a plurality of terminal devices select overlapping resources for a plurality of sidelink (SL) positioning reference signal (PRS) transmissions; and means for based on determining that the plurality of terminal devices select overlapping resources for the plurality of SL PRS transmissions, transmit, to a second terminal device among the plurality of terminal devices, a request to update an SL PRS transmission by the second terminal device.

In some embodiments, the apparatus may include means for receiving, from a network device, a configuration of mapping restriction for performing a logical channel prioritization (LCP) procedure associated with a configured grant (CG). The mapping restriction is configured for a medium access control (MAC) control element (CE). The apparatus further may include means for determining whether the MAC CE is triggered; means for performing, based on determining the MAC CE is triggered, the LCP procedure for the CG based on the mapping restriction; and means for transmitting the MAC CE to the network device via the CG.

In some embodiments, the request comprises a request for muting a SL PRS. In some embodiments, the request further indicates that the SL PRS is muted in a first slot. In some embodiments, the apparatus further comprises means for transmitting, to a third terminal device of the plurality of terminal devices, the request for muting the SL PRS in a second slot, and the second slot and the first slot being staggered in the time domain. In some embodiments, means for transmitting the request for muting the SL PRS comprises: means for receiving a first SL PRS from the second terminal device and a second SL PRS from a third terminal device among the plurality of terminal devices on the overlapping resources; means for determining that a first received power of the first SL PRS is greater than a second received power of the second SL PRS by a power threshold; and means for transmitting the request for muting the first SL PRS to the second terminal device.

In some embodiments, the means for transmitting the request for muting the SL PRS comprises means for receiving, from a network device, a muting criterion for determining the SL PRS to be muted; and means for transmitting, based on the muting criterion, the request to the second terminal device. In some embodiments, the request comprises: a request for muting a beam associated with the SL PRS transmission. In some embodiments, the means for transmitting the request for muting the SL PRS by at least one of: means for transmitting the request via a sidelink control information (SCI) signaling; means for transmitting the request via a sidelink LTE positioning protocol (SLPP) message; or means for transmitting the request via a group cast signaling to mute the SL PRS transmitted from a group of terminal devices among the plurality of terminal devices.

In some embodiments, the apparatus further comprises means for receiving, from the second terminal device, an indication that the SL PRS is not to be muted; and means for transmitting the request to a third terminal device other than the second terminal device among the plurality of terminal devices. In some embodiments, the request comprises at least one of: a request for changing an SL PRS identification (ID); or a request for using an orthogonal cover code (OCC). In some embodiments, the request further indicates at least one of: an SL PRS ID, or an SL PRS sequence initialization.

In some embodiments, the means for transmitting the request for changing the SL PRS ID comprises means for determining a first distance between the terminal device and the second terminal device; means for determining a second distance between the terminal device and a third terminal device of the plurality of terminal devices; and means for transmitting, based on a distance difference between the first distance and the second distance satisfying a distance threshold, the request for changing the SL PRS ID or the request for using the OCC to the second terminal device.

In some embodiments, the apparatus further comprises means for receiving, from the second terminal device, an indication of a muting pattern. In some embodiments, the means for transmitting the request comprises means for transmitting, to the second terminal device, an activation message for activating the muting pattern.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

In some embodiments, an apparatus capable of performing any of the method 500 (for example, the second terminal device 120) may include means for performing the respective steps of the method 500. The means may be implemented in any suitable form. For example, the means may be implemented in a circuitry or software module.

In some embodiments, the apparatus may include means for transmitting a sidelink (SL) positioning reference signal (PRS) configuration to a first terminal device; means for receiving a request to update an SL PRS transmission; and means for updating, in accordance with a determination that the SL PRS is to be updated, the SL PRS transmission based on the request.

In some embodiments, the request comprises a request for muting a SL PRS. In some embodiments, the request comprises: a request for muting a beam associated with the SL PRS.

In some embodiments, the means for updating the SL PRS transmission comprises at least one of: means for muting transmitting the SL PRS based on the request; or means for disabling the beam associated with the SL PRS.

In some embodiments, the second terminal device avoids transmitting the SL PRS, and wherein the second terminal device is further caused to: transmit, to another terminal device to be positioned, an indication that the SL PRS is muted.

In some embodiments, the apparatus further comprises means for transmitting, in accordance with a determination that the SL PRS is not to be updated, an indication that the SL PRS is not to be muted.

In some embodiments, the request comprises at least one of: a request for changing a SL PRS Identification (ID); or a request for using an orthogonal cover code (OCC).

In some embodiments, the request further indicates at least one of: n SL PRS ID, or an SL PRS sequence initialization.

In some embodiments, the apparatus further comprises means for at least one of: change, based on the request for changing a SL PRS ID, the code sequence for the SL PRS transmission to the first terminal device; and use, based on the request for using the OCC, the OCC for the SL PRS transmission to the first terminal device.

In some embodiments, the apparatus further comprises means for receiving, from a network device, an indication of muting pattern; and transmit, to the first terminal device, the indication of the muting pattern.

In some embodiments, the apparatus further comprises means for receiving, from the first terminal device, an activation message for activating the muting pattern; and activate the muting pattern.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing any of the method 600 (for example, the network device 150) may include means for performing the respective steps of the method 600. The means may be implemented in any suitable form. For example, the means may be implemented in a circuitry or software module.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, the apparatus may include means for transmitting, at a network device, a muting criterion for determining sidelink (SL) positioning reference signal (PRS) to be muted to a first terminal device; and means for transmitting an indication of muting pattern to a second terminal device.

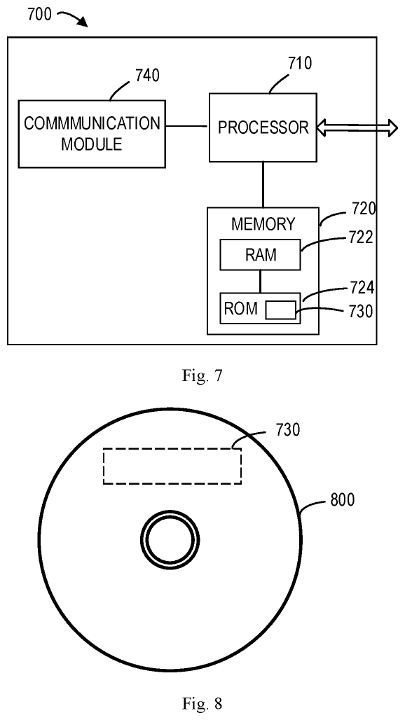

FIG. 7 is a simplified block diagram of a device 700 that is suitable for implementing embodiments of the present disclosure. The device 700 may be provided to implement the communication device, for example the terminal devices or network device 150 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 630 into the RAM 722.

The embodiments of the present disclosure may be implemented by means of the program so that the device 600 may perform any process of the disclosure as discussed with reference to FIGS. 2 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out process 200 or 300, the method 400, 500 or 600 as described above with reference to FIG. 2 to FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first terminal device comprising:
at least one processor; and
at least one memory storing instructions that, when executed by the at least one processor, cause the first terminal device to:
receive a plurality of sidelink (SL) positioning reference signal (PRS) configurations from a plurality of terminal devices;
determine, based on the plurality of SL PRS configurations, whether the plurality of terminal devices select overlapping resources for a plurality of SL PRS transmissions; and
based on determining that the plurality of terminal devices select overlapping resources for the plurality of SL PRS transmissions, transmit, to a second terminal device among the plurality of terminal devices, a request to update an SL PRS transmission by the second terminal device.

2. The first terminal device of claim 1, wherein the request comprises a request for muting a SL PRS.

3. The first terminal device of claim 2, wherein the request further indicates that the SL PRS is muted in a first slot, and wherein the first terminal device is further caused to transmit, to a third terminal device of the plurality of terminal devices, the request for muting the SL PRS in a second slot, and the second slot and the first slot being staggered in the time domain.

4. (canceled)

5. The first terminal device of claim 2, wherein the first terminal device is caused to transmit the request for muting the SL PRS by:
receiving a first SL PRS from the second terminal device and a second SL PRS from a third terminal device among the plurality of terminal devices on the overlapping resources;
determining that a first received power of the first SL PRS is greater than a second received power of the second SL PRS by a power threshold; and
transmitting the request for muting the first SL PRS to the second terminal device.

6. The first terminal device of claim 2, wherein the first terminal device is caused to transmit the request for muting the SL PRS by:
receiving, from a network device, a muting criterion for determining the SL PRS to be muted; and
transmit, based on the muting criterion, the request to the second terminal device.

7. The first terminal device of claim 2, wherein the request comprises a request for muting a beam associated with the SL PRS transmission.

8. The first terminal device of claim 2, wherein the first terminal device is caused to transmit the request for muting the SL PRS by at least one of:
transmitting the request via a sidelink control information (SCI) signaling;
transmitting the request via a sidelink LTE positioning protocol (SLPP) message; or
transmitting the request via a group cast signaling to mute the SL PRS transmitted from a group of terminal devices among the plurality of terminal devices.

9. The first terminal device of claim 2, wherein the first terminal device is further caused to:
receive, from the second terminal device, an indication that the SL PRS is not to be muted; and
transmit the request to a third terminal device other than the second terminal device among the plurality of terminal devices.

10. The first terminal device of claim 1, wherein the request comprises at least one of a request for changing an SL PRS identification (ID) or a request for using an orthogonal cover code (OCC); and wherein the request further indicates at least one of an SL PRS ID or an SL PRS sequence initialization.

11. (canceled)

12. The first terminal device of claim 10, wherein the first terminal device is caused to transmit the request for changing the SL PRS ID by:
determining a first distance between the terminal device and the second terminal device;
determining a second distance between the terminal device and a third terminal device of the plurality of terminal devices; and
transmitting, based on a distance difference between the first distance and the second distance satisfying a distance threshold, the request for changing the SL PRS ID or the request for using the OCC to the second terminal device.

13. The first terminal device of claim 1, wherein the first terminal device is further caused to:
receive, from the second terminal device, an indication of a muting pattern.

14. The terminal device of claim 13, wherein the first terminal device is caused to transmit the request by:
transmitting, to the second terminal device, an activation message for activating the muting pattern.

15. A second terminal device comprising:
at least one processor; and
at least one memory storing instructions that, when executed by the at least one processor, cause the terminal device to:
transmit a sidelink (SL) positioning reference signal (PRS) configuration to a first terminal device;
receive a request to update an SL PRS transmission; and
update, in accordance with a determination that the SL PRS is to be update, the SL PRS transmission based on the request.

16. The second terminal device of claim 15, wherein the request comprises at least one of:
a request for muting a SL PRS, or
a request for muting a beam associated with the SL PRS.

17. (canceled)

18. The second terminal device of claim 16, wherein the second terminal device is caused to update the SL PRS transmission by at least one of:
muting transmitting the SL PRS based on the request; or
disabling the beam associated with the SL PRS.

19. The second terminal device of claim 16, wherein the second terminal device avoids transmitting the SL PRS, and wherein the second terminal device is further caused to:
transmit, to another terminal device to be positioned, an indication that the SL PRS is muted.

20. The second terminal device of claim 16, wherein the second terminal device is further caused to:
transmit, in accordance with a determination that the SL PRS is not to be updated, an indication that the SL PRS is not to be muted.

21. The second terminal device of claim 15, wherein the request comprises at least one of a request for changing a SL PRS Identification (ID) or a request for using an orthogonal cover code (OCC); and wherein the request further indicates at least one of an SL PRS ID or an SL PRS sequence initialization.

22-26. (canceled)

27. A method comprising:
receiving, at a first terminal device, a plurality of sidelink (SL) positioning reference signal (PRS) configurations from a plurality of terminal devices;
determining, based on the plurality of SL PRS configurations, whether the plurality of terminal devices select overlapping resources for a plurality of sidelink (SL) positioning reference signal (PRS) transmissions; and
based on determining that the plurality of terminal devices select overlapping resources for the plurality of SL PRS transmissions, transmitting, to a second terminal device among the plurality of terminal devices, a request to update an SL PRS transmission by the second terminal device.

28. A method comprising:
transmitting a sidelink (SL) positioning reference signal (PRS) configuration to a first terminal device;
receiving a request to update an SL PRS transmission; and
updating, in accordance with a determination that the SL PRS is to be updated, the SL PRS transmission based on the request.

29-33. (canceled)
